(19) United States
(12) Patent Application Publication
(10) Pub. No.: US 2016/0371663 A1
(43) Pub. Date: Dec. 22, 2016

(54) Information Exchange System and Methods

(71) Applicant: Bruce Knuteson, New York, NY (US)

(72) Inventor: Bruce Knuteson, New York, NY (US)

(21) Appl. No.: 15/182,470

(22) Filed: Jun. 14, 2016

Related U.S. Application Data
(60) Provisional application No. 62/180,742, filed on Jun. 17, 2015.

(51) Int. Cl. G06Q 20/10; G09B 7/02

(52) U.S. Cl. CPC G06Q 20/102; G09B 7/02

(57) ABSTRACT

The disclosed computer system enables an information exchange that allows anonymous parties to agree up front on a particular package of information that will be useful to the buyer. The disclosed information exchange can structure transactions in a way that causes an information seller to lose money if she turns out to be wrong, forcing information sellers to have skin in the game. The computer system can also be used to actively match buyers and sellers, including those who may not yet be aware of the exchange's existence. The systems and methods for operating an effective information exchange described herein greatly facilitate the paid, arm's-length transfer of useful and accurate information.

### CROSS-REFERENCES TO RELATED APPLICATIONS

This application claims priority from and incorporates herein by reference in its entirety U.S. Provisional Patent Application No. 62/180,742, dated Jun. 17, 2015.

### BACKGROUND OF THE INVENTION

Field of the Invention

The present invention relates to information exchanges. More specifically, the invention relates to platforms that facilitate the buying and selling of answers to specific questions.

Discussion of Related Art

Websites like Quora, Yahoo! Answers, Google Questions and Answers, Ask.com, Reddit, Question.com, StackOverflow, StackExchange, and many others provide forums in which users pose questions that are answered by other users.

Some of these sites provide users an easy mechanism for “voting” on the quality of provided answers. These votes affect users' reputations, in an effort to incentivize quality answers. Such sites do not enable answerers to earn income for providing answers, nor do they enable questioners to pay for answers to questions they particularly care about.

Other sites use a pool of verified “experts” who are paid by the questioner for providing satisfactory answers. Such sites often also include a review-based reputation system to encourage quality answers. These sites must verify their “experts,” and they often limit questions to “expert” areas (such as medicine, accounting, or law). If an “expert” provides a poor answer, the most he stands to lose is his reputation on that particular site.

Law enforcement has for many years accepted anonymous tips, usually without reward. Law enforcement has also for many years offered monetary rewards for (usually non-anonymous) information leading to the location of certain individuals, or for information leading to an arrest for certain crimes. Whistleblower programs (e.g., the Securities and Exchange Commission's Office of the Whistleblower) also offer monetary rewards for information leading to specific outcomes. While an individual may obtain $10,000 for providing information leading to a felony conviction, or $100,000 for providing information leading to a Securities and Exchange Commission enforcement action in which $1,000,000 in sanctions is ordered, these methods do not readily allow law enforcement to pay an anonymous informant $500 for a potentially useful lead, and they do not readily allow regulators to pay $2,000 for a piece of knowledge that, while not demonstrating outright fraud, may shed important light on some aspect of a market's operation.

What is desired is an information exchange that enables paid, arm's length transfers of information between two anonymous parties. The information exchange must provide a transaction protocol ensuring up-front agreement between buyer and seller as to the form of the information to be exchanged, allowing the buyer to be confident the information she is paying for will be useful to her. This transaction protocol must also give the information exchange a way of identifying and rewarding a seller who provides information that turns out to be correct, and penalizing a seller who provides information that turns out to be incorrect, thereby forcing the information seller to have skin in the game.

What is desired is an information exchange enabling many activities that are currently cumbersome or impossible due to lack of a practical system for paid, arm's length information transfer. A brief list of examples effectively illustrates the extraordinarily broad scope of such activities.

Individuals should be able to provide anonymous, paid leads to law enforcement and/or regulatory agencies, in amounts reflecting the willingness of the agency to pay for the information, in a way that does not encourage the reporting of false leads.

Scientists should be able to buy and sell knowledge learned in the course of research. Such knowledge may span the range from technical minutiae (e.g., specific protocols) to answers to large scientific questions.

Individuals should be able to pose and answer specific medical and legal questions, including for preliminary and second opinions, in a way that ensures the answerer has a real, monetary stake in the correctness of her answer.

Individuals should be able to ask questions about other individuals using a technology that better elicits the truth than simply asking a mutual acquaintance, where social and reputational incentives significantly skew blunt honesty.

Pharmaceutical companies should have a way of anonymously seeking information relevant to any drug they are considering bringing to trial. The experience of a clinician halfway around the world who has toyed with a similar treatment could save hundreds of millions of dollars on a probably doomed drug trial. Far more about what works and what does not is known than is published.

What is further desired is an information exchange that sufficiently facilitates the arm's length transfer of information to provide secondary benefits of potentially even greater scope. If scientists can sell what they learn from their research, the economic value of the knowledge that can be harvested from the biodiversity in an acre of tropical rainforest may exceed the economic value of the crops that can be harvested if that same acre is converted to farmland, thereby slowing the deforestation of the world's jungles. Such secondary benefits are likely to be far reaching.

What is desired is an information system wherein individuals can easily buy and sell answers to a wide range of simple questions, using a transaction protocol that properly aligns incentives of all involved parties.

### BRIEF SUMMARY OF THE INVENTION

It is an object of this invention to construct an incentive system that promotes honest, arm's length information transfer.

It is an object of this invention to provide a method for the buying and selling of answers to specific questions between anonymous parties in a manner that rewards correct answers and penalizes incorrect answers.

A further object of this invention is to provide a method for determining the Final Answer to questions in a manner that may be used to determine which answer(s) should be rewarded, and which should be penalized.

Another object of this invention is to facilitate the practical use of an information exchange by individuals who may have only a passing familiarity with the underlying transaction protocol.

Another object of this invention is to provide methods for matching questions with likely answerers, and to facilitate the subsequent anonymous posing and answering of potentially useful variants of an initial question.

Another object of this invention is to provide methods by which individuals with specific information may easily sell that information to people willing to pay for it.

### BRIEF DESCRIPTION OF THE DRAWINGS

FIG. 1 depicts an input box enabling a user to submit a question to the exchange.

FIG. 2 depicts an example of a “good” question.

FIG. 3 depicts a user submitting a “Who?” multiple choice question, explicitly specifying the set of possible answers.

FIG. 4 depicts a question posed to the information exchange by an answerer, together with the answerer's answer.

FIG. 5 depicts a buy order indicating how much the buyer is willing to pay for an answer, and specifying the date by which she wants to know the answer.

FIG. 6 depicts a multiple-choice question with an initial probability assigned to each possible answer.

### DETAILED DESCRIPTION

In this detailed description, the following sets of words or word phrases are considered synonymous and may be used interchangeably:

Information and knowledge

Marketplace, market, exchange, and platform

X, information exchange, and knowledge exchange

Q, questioner, information buyer, answer purchaser, and buyer

A, answerer, information seller, seller, answer provider, and informant

Belief and probability

Eliminating incentives other than purely monetary incentives is desirable for the objective of constructing an incentive system that promotes honest, arm's length information transfer. Eliminating social and reputational incentives can be achieved through anonymity.

The buying and selling of information encounters three difficulties present to a lesser degree in other transactions. Resolution of these three difficulties is described below in Sections A, B, and C.

### Section A. Information Usefulness: Questions and Possible Answers

The first of these three difficulties is that it is often difficult for the buyer to know whether information will be useful until after the buyer has received the information, at which point the seller is unable to charge for it. Resolving this difficulty necessarily requires an up-front agreement between the buyer and seller as to the usefulness (to the buyer) of the information being exchanged.

This up-front agreement can be facilitated by providing an information exchange (X) that allows the information buyer (Q) and the information seller (A) to agree on a specific question and a set of possible answers to that question.

This section (Section A) describes how to structure the transaction to ensure the information transferred is useful (to Q), assuming the information is accurate. That is, this section describes how to set up a transaction whereby Q can ask “Where does Bruce Knuteson currently live?” in a way that discourages (accurate, but unhelpful) answers like “on earth.” Incentivizing accuracy is the subject of Section B.

As described below, information is conveyed in the form of answers to specific questions. The information buyer is the questioner, Q. The information seller is the answerer, A.

Associated with every question is a set of possible answers to that question. This feature limits the type of questions that may be asked to Yes/No questions; multiple-choice questions, with explicitly specified possible answers; and fill-in-the-blank questions, with an explicitly specified category for allowed possible answers (e.g., “a complete U.S. mailing address”).

A Yes/No question may be considered to be a limiting case of a multiple-choice question. A Yes/No question is a multiple-choice question with only two possible answers: Yes and No.

The possible answers in good multiple-choice questions are mutually exclusive and contain the possible answer “other.” Good multiple-choice questions have exactly one correct answer. That is, the possible answers to a good multiple-choice question are complete (at least one answer is correct) and mutually exclusive (at most one answer is correct).

Fill-in-the-blank questions may be considered to be a limiting case of multiple-choice questions with many possible answers. Although it may not be possible to list all possible answers, it is easy to determine whether any offered answer fits into the specified category. For example, although it may not be possible to list all U.S. mailing addresses, it is easy to determine whether an offered answer is a valid U.S. mailing address. Similarly, although it is certainly not possible to list all conceivable videos clips of a dog falling down stairs, it is in most cases easy to determine whether a particular video clip shows a dog falling down stairs.

Restricting the types of questions that may be asked helps ensure that any answers the questioner Q receives will be useful to her.

In one embodiment, the user is presented with a single input box into which she can type her question. Automatically guiding the user to ask a “good” question has been found to be important. To this end, the interface forces the question to be expressed as a single sentence, ending with a question mark, at the top of the input box. This single sentence, ending with a question mark, will here and below be called the “short form” of the question.

Additional clarification, almost always necessary for a good question, can be provided in one or more additional paragraphs after the short form of the question. These additional clarifying paragraphs will here and below be called the “long form” of the question. These paragraphs may, among other things: uniquely specify the identity of a person, place, or thing referenced in the short form of the question; clarify any jargon used in the short form of the question; clarify acceptable possible answers; and, if necessary, clarify payouts in certain possible outcomes.

Video, images, or other media may be added to the question, as necessary. The ability to include media with a question may be particularly helpful for questions in the fields of science and medicine, among others. References to other relevant online media may be provided as links in the long form of the question.

Real time feedback in the user interface significantly improves the quality of user questions. These features include the identification of words and phrases that tend to indicate poor questions. “Why?” questions tend to be poor questions, since the accuracy of any provided answer is invariably difficult to determine. Questions containing subjective words such as “best,” “better,” “good,” or their negative counterparts tend to be poor questions, since it is usually difficult to assess whether any particular answer is (objectively) correct. Questions beginning with “can,” “could,” “should,” or “would” frequently lead to similar difficulties in eventually assessing the accuracy of answers received. Other indicators of poor questions include confusing words or phrases, unclarified acronyms, words of ambiguous sign (e.g., “won't”), and unnecessarily offensive language.

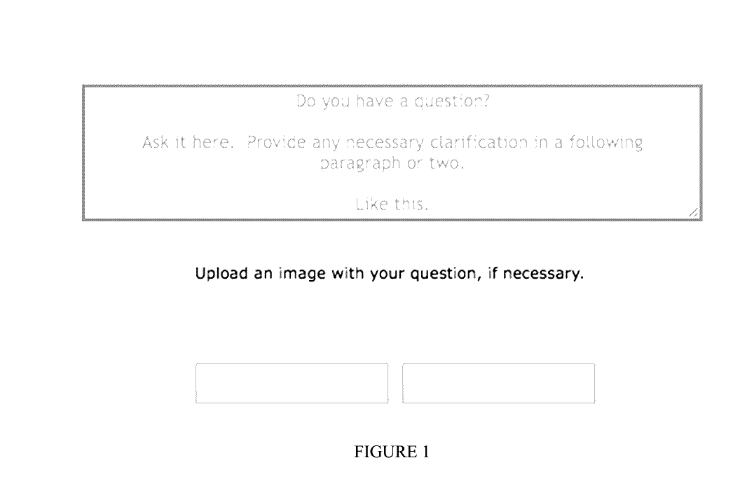

Software that identifies these common problems in real time, as the user is typing her question, and gently guides her to reformulate her question is critical for ensuring the quality of questions posed on the information marketplace. A gentle, specific nudge to the user suggesting a way of improving her question at this stage can save considerable pain later in adjudicating Final Answers to ambiguous questions. In the embodiment of this invention shown in FIG. 1 the user cannot proceed to the next step in the process until her question satisfies these checks. The “I Want to Know” and “I Know” buttons are initially grayed out, and become active only after the user's question satisfies these checks.

In many languages, including English, software can categorize a question a user has asked as Yes/No, multiple-choice, or fill-in-the-blank. In English, questions leading with how, what, which, where, who, or when are multiple-choice or fill-in-the-blank questions. Questions leading with are, am, is, was, were, will, has, have, do, does, or did are Yes/No questions. Correctly categorizing the type of question in real time is important in helping the user specify allowed possible answers to her question. If the software is unsuccessful in automatically categorizing a question as Yes/No on the one hand, or multiple-choice or fill-in-the-blank on the other, the user is guided to reword her question, usually by bringing the question word to the front of her question.

If the user's question is a Yes/No question, no further specification of the set of possible answers is necessary.

If the question is not a Yes/No question, the user must specify whether her question is a multiple-choice question or a fill-in-the-blank question. This decision may be made for the user in certain cases, including questions leading with “What fraction of”, where it is usually best to force the user into providing multiple-choice answers, specifically delineating the ranges of fractions among which she wishes to distinguish.

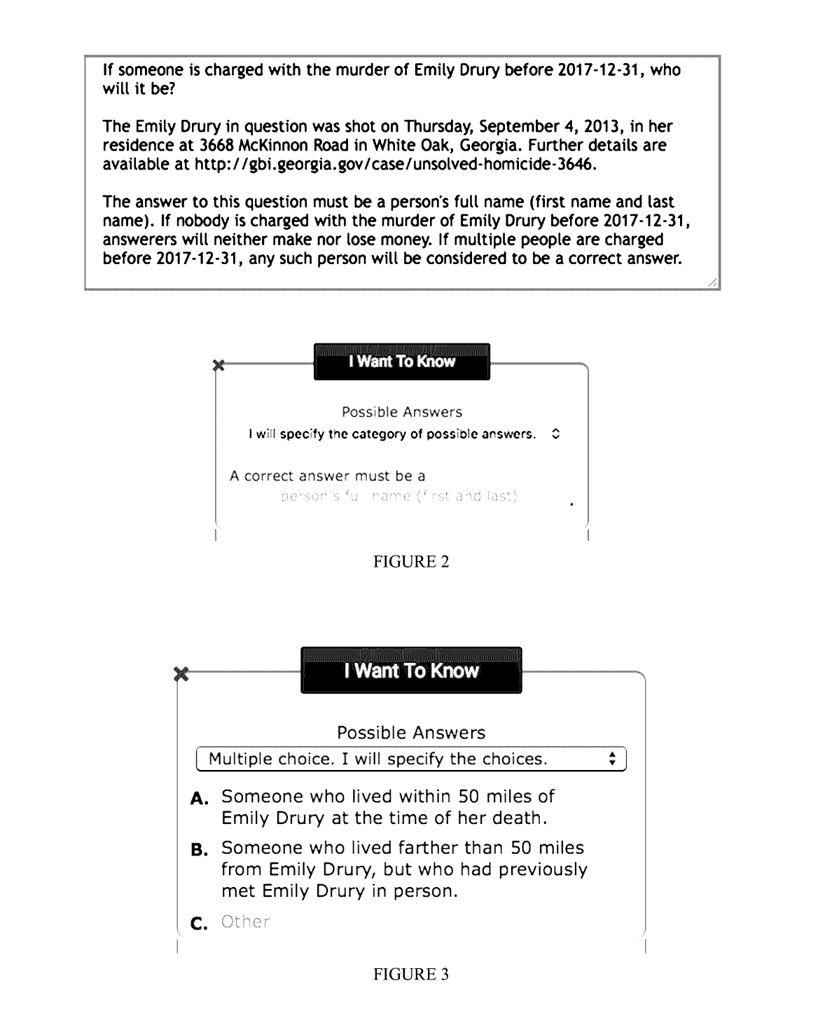

FIG. 2 shows an example of a “Who?” question. The question “short form” is the (one sentence) question at the top of the box. Note that the questioner has turned the obvious question (“Who killed Emily Drury?”) into a much better, related question (“If someone is charged with the murder of Emily Drury before 2017-12-31, who will it be?”). The second paragraph in the box provides further clarifying details about the homicide, including a link to an external web site. The third paragraph in the box clarifies payouts in cases that might otherwise be ambiguous, including what happens if nobody is charged, and what happens if multiple people are charged. The bottom half of the figure shows an example of a user asking a “Who?” question, indicating that the set of possible answers is any person's full name (first name and last name).

In FIG. 2, the user is given the option to make the question fill-in-the-blank (“I will specify the category of possible answers.”) or multiple-choice (“Multiple-Choice. I will specify the choices.”). If the user opts to make her question a fill-in-the-blank question, she can specify the category of possible answers. In this case, a category such as “a person's full name (first and last)” may be appropriate.

The user can turn the question in FIG. 2 into a very different question by changing it from a fill-in-the-blank question to a multiple-choice question and explicitly specifying the set of possible answers shown in FIG. 3. In this case, the question's short form and long form are the same as in the box in the top half of FIG. 2, but the set of possible answers is meaningfully different from the set of possible answers shown in the bottom half of FIG. 2. In FIG. 3, the questioner is asking about the relationship between the likely murderer and Emily Drury, rather than for the name of the likely murderer. Note that the possible answers in FIG. 3 are constructed to be mutually exclusive, with the possible answer “Other” ensuring the set of possible answers is complete.

Whether the set of possible answers in FIG. 2, or the set of possible answers in FIG. 3, is most appropriate depends on both the goals of the questioner and the willingness and ability of potential answerers to answer.

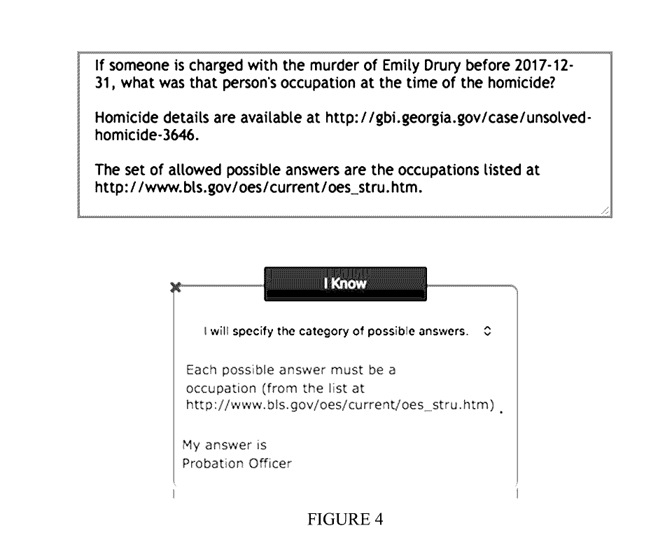

Questions on the information exchange may be initiated by answerers. A waitress or bartender who at some point overhears a bit of conversation seeming to refer to this homicide may not catch enough to answer the question in FIG. 2 or the variant in FIG. 3, but she may catch enough to warrant posing the question shown in FIG. 4, and providing her answer. The question shown in FIG. 4 will be viewable by people who may wish to purchase the answer. The answer (in this case, “Probation Officer”) will only be viewable by the person(s) paying to view the answer. The waitress or bartender has the option of making her question publicly viewable or hidden. The answer she provides will be shown only to the person(s) paying for it. If nobody is willing to pay to view her answer, nobody will see her answer.

The transaction resulting from an answerer initiating a question and someone subsequently choosing to purchase the answer is equivalent to the transaction resulting from a questioner posing a question and someone subsequently choosing to answer it.

To summarize Section A, the question's short form, the additional clarifying paragraphs of the question's long form, any accompanying media, and the set of possible answers, taken together, ensure that any correct answer received will be of use to the questioner. The purpose of Section A has been to show how to structure transactions in a manner that protects the questioner from receiving answers that are correct but not useful. Without the detail specified in this section, a questioner asking “If someone is charged with the murder of Emily Drury before 2017-12-31, who will it be?” and receiving the answer “a person between the ages of 10 and 100 years old” is forced to concede that the answer, although completely unhelpful, is almost certainly correct. The package detailed in Section A, particularly the specification of the set of possible answers illustrated in FIG. 2 and FIG. 3, makes it easy for the information exchange to penalize answerers who provide answers that are not among the set of agreed upon possible answers, including answers like “a person between the ages of 10 and 100 years old.” This ease, in turn, means answers like this are almost never submitted in the first place.

Having addressed the issue of penalizing answers that are accurate but unhelpful, a problem that continues to plague the majority of online forums and question and answer sites, we turn to the issue of penalizing inaccurate answers.

### Section B. Information Accuracy: Final Answers and Payouts

A second difficulty in achieving an arm's length buying and selling of information is that it is difficult for the buyer to know whether the information is accurate until after the buyer has received the information (at which point the seller is unable to charge for it).

Caveat emptor is nowhere more appropriate than in markets with large information asymmetry. The market for information is the limiting case of a market with infinite information asymmetry. Resolving this second difficulty clearly requires a procedure for (eventually) determining the accuracy of the seller's information, together with some way of rewarding (penalizing) the seller if her information turns out to be accurate (inaccurate).

This second difficulty can be resolved by requiring the information seller (A) to provide money that is held in escrow until the Final Answer to the question is determined. This serves as collateral for the accuracy of A's answer. If A turns out to be incorrect, she forfeits the amount held in escrow. If A turns out to be correct, she gets her money back, plus profit. The transfer of information thus requires the information exchange (X) to hold in escrow money from both questioners (Q) and answerers (A).

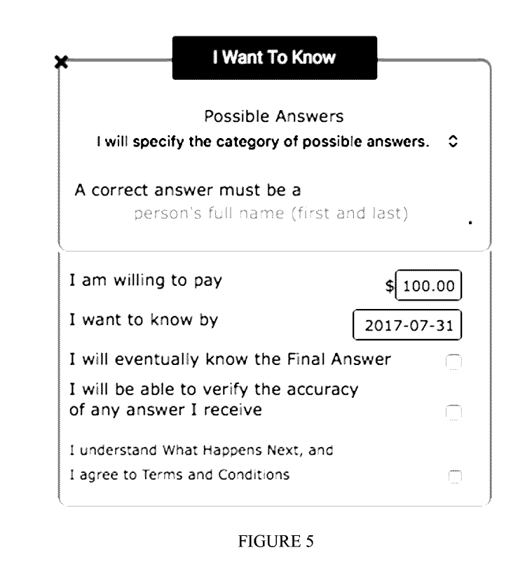

FIG. 5 shows, in one embodiment, further detail a questioner Q may provide when posing a question to the exchange. Q provides the money (here, $100) she is willing to pay for an answer to her question. Q's $100 is held in escrow by the information exchange (X). Q wants to know the answer by 2017 Jul. 31. If Q receives no answers by this date, the money held in escrow is returned to her the following day. Q affirms that she will eventually know the Final Answer or be able to verify the accuracy of any answer she receives. This is important. Questions for which Q will eventually know the Final Answer (through some means other than through the information exchange) or will be able to verify the accuracy of any answer she receives are good questions. In practice, we find these are the questions informed answerers are most willing to answer. These also typically end up being the questions whose answers are most directly useful to the questioner.

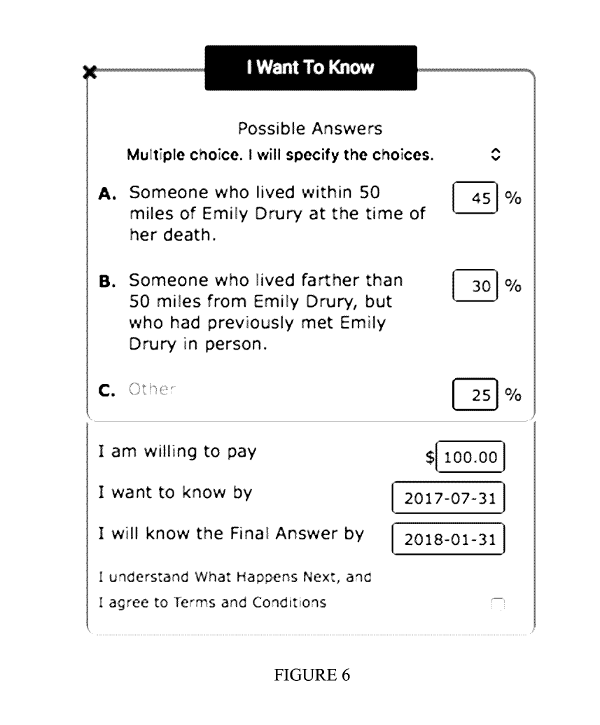

FIG. 6 shows an “I Want to Know” dialog box similar to FIG. 5, but for the multiple-choice form of the question shown in FIG. 3. In FIG. 6, Q has already affirmed that she will eventually know the Final Answer, and has provided the date by which she expects to know the Final Answer. For this question (the text of which is shown in FIG. 2), Q expects to know the Final Answer by Jan. 31, 2018.

For some fill-in-the-blank questions (e.g., “Where does Bruce Knuteson currently live?”), it may be more convenient for Q to verify the accuracy of answers she receives than to determine the Final Answer. In such cases, instead of setting a date by which she promises to determine the Final Answer, Q can promise to verify the accuracy of any answer she receives within some specified time of receiving it. For example, Q may promise to verify the accuracy of any answer she receives within (say) 7 days of receiving it. Moreover, if Bruce Knuteson currently lives in more than one place, there would be more than one correct answer to the question. Therefore, the Final Answer could be described as the aggregate set of the verifications of each sell answer, which would be a list of places where he currently lives and a list of places where he does not.

In FIG. 6, Q has also chosen to provide her initial beliefs, expressed as probabilities, in each of the three possible answers. To streamline transactions and minimize user confusion, the option to provide these initial beliefs may be made more (less) salient for expert (non-expert) users. In this case, Q thinks the answer is “someone who lived within 50 miles of Emily Drury at the time of her death” with probability 45%; “someone who lived farther than 50 miles from Emily Drury, but who had previously met Emily Drury in person” with probability 30%; and “Other” with probability 25%. The sum of these probabilities is 100%. Q's initial beliefs are hidden, and used only for the purpose of calculating payouts, as described later in this Section.

Information buy orders can partially transact on the information exchange. This allows information buy orders to transact against multiple information sell orders, allowing questioners to receive answers from multiple answerers. Similarly, information sell orders can partially transact on the information exchange. This allows information sell orders to transact against multiple information buy orders, allowing answerers to sell their answers to multiple people who want to know.

Both questioners and answerers may set limits on these partial transactions, if they wish. To streamline transactions and minimize user confusion, the option to set limits on these partial transactions may be made more (less) obvious to expert (non-expert) users. The answerer (A) may elect to specify the minimum amount of money that must transact for a questioner to be able to view her answer, thereby placing a minimum price on A's answer. By default, this minimum amount is the full amount A has on the line backing her answer, and no buyer can view the answer without paying at least this amount. Similarly, the questioner (Q) may elect to provide a minimum amount of money an answerer must put on the line to answer this question.

In one embodiment, buy orders and sell orders are matched in time priority (i.e., orders are executed in the order in which they are received by the information exchange), with as much money transacting as allowed by the following constraints. 1. Sell orders backed by money in escrow until time T may only transact with buy orders whose Final Answer deadline is no later than 24 hours earlier than time T. If this constraint is not satisfied, no transaction occurs. 2. All transactions must be in amount greater than or equal to both the minimum transaction threshold set by the questioner (which defaults to zero) and the minimum threshold set by the answerer (which defaults to the full amount of money backing the answerer's answer). If this constraint cannot be satisfied, no transaction occurs. 3. Under the algorithm for payouts previously described, for the full range of possible outcomes, the answerer may not stand to lose more money than she has in escrow. 4. Under the algorithm for payouts previously described, for the full range of possible outcomes, the answerer may not stand to make more money than the amount officially set aside to pay the answerer. A simple example of these constraints in action is provided later in this Section.

A process for determining each question's Final Answer is also enabled by the disclosed information exchange. If this process is unfair (or perceived as unfair), answerers will be unwilling to back their answers with money, and questioners will be unsatisfied with the answers they receive.

The person tasked with providing the Final Answer may be the questioner (Q), the information exchange (X), or the answerer (A), depending on the question. These three cases are covered in the following paragraphs. In all cases, the information exchange (X) is responsible for judging the sufficiency of the evidence provided to support the claimed Final Answer.

For many questions, the problem of determining the Final Answer can be outsourced to the questioner (Q). Specifically, the information exchange (X) pays Q to eventually learn the Final Answer, tell X, and provide evidence—in the form of (say) a couple of sentences and a hyperlink, image, or video clip—sufficient to convince X that the Final Answer provided is indeed correct. The sole responsibility for determining the Final Answer is given to Q, since she is the person most likely to (eventually) be knowledgeable about the Final Answer, and since she is the person most likely to be objective about the Final Answer.

X pays Q to incentivize her to eventually provide the Final Answer. In one embodiment of the invention, X requires Q to put up a deposit. The deposit is eventually returned to Q if she provides the Final Answer, provided she does so before the Final Answer deadline she has set (in the “I will know the Final Answer by” box in FIG. 6), and provided X considers the evidence Q provides sufficient to justify Q's Final Answer. The amount of the deposit should be large enough to incentivize Q to return to X to provide the Final Answer, but not so large that Q is reluctant to enter into the transaction in the first place. A matching deposit ($1 of deposit for every $1 Q is willing to pay) seems to work well in practice. For simplicity, we proceed with this discussion assuming a matching deposit.

If the Final Answer deadline passes before Q submits a Final Answer that X approves, Q forfeits her deposit. Q's forfeited deposit is added to a pot, the contents of which are distributed to all questioners monthly in proportion to the amount each questioner has transacted that month. This periodic distribution of forfeited money is important in aligning the incentives of X itself, which would otherwise have an economic incentive to deny Final Answers.

The alignment of incentives of the participants in each transaction is of paramount importance. Paying Q to provide the Final Answer incentivizes Q to ask a question to which she will eventually know the Final Answer, in addition to incentivizing her to subsequently learn and justify the Final Answer to X. Answerers, all of whom obviously have a vested interest in the determination of the Final Answer, play no role in determining the Final Answer. Q has no economic incentive to lie in her Final Answer—X returns Q's deposit regardless of what the Final Answer is, as long as Q can justify the Final Answer Q provides. Q does have a misaligned incentive to provide a Final Answer, even if it is one she cannot fully justify. This misaligned incentive is balanced by X, which may require Q to provide evidence justifying Q's Final Answer “beyond reasonable doubt,” with roughly the same standard as currently used in the United States legal system. X makes the same amount on each transaction, regardless of whether it approves or denies Q's Final Answer. X has a clear economic interest in adjudicating Final Answers as quickly, objectively, and cleanly as possible, since its future business relies on the adjudication process being perceived as fair. Thus, the interests of each party is appropriately aligned at each step of the transaction.

For some questions, X may be able to accept responsibility for determining the Final Answer. These questions include questions to which the Final Answer will eventually be widely known (e.g., “Will Vladimir Putin be the President of Russia on 2017-12-31?”) and questions containing clear instructions by which X may itself determine the Final Answer (e.g., “What were the total actual administrative expenses for San Bernardino County in Fiscal Year 2014-15? For the purpose of this question, the Final Answer will be the number appearing in the 2016-17 budget at http://www.sbcounty.gov. The corresponding number for the 2013-14 fiscal year appears in Appendix A on page 691 of http://www.sbcounty.gov/Uploads/CAO/Budget/2015-2016-0/County/Adopted/2015-2016-0-CountyAdopted.pdf.”)

If X accepts responsibility for determining the Final Answer, the money flow can differ from that previously described. Although the payouts to X and A remain the same, X can go ahead and return Q's deposit as soon as X accepts responsibility for determining the Final Answer. With Q no longer involved in determining the Final Answer, Q can get some (or all) of her money back if Q receives an incorrect answer. A worked example of this is provided later in this Section.

For some questions, the answerer (A) is actually the appropriate person to provide evidence supporting the Final Answer. If A wishes to sell the amount she earns in wage income or the amount she pays in rent, Q is unlikely to be able to independently verify the accuracy of A's answer, but A should be able to provide sufficient evidence (e.g., a W-2 form or a monthly bill) to X. In such cases, A may have an economic incentive to deceive. X must set a correspondingly high bar when determining the sufficiency of A's evidence. If A provides evidence that X approves, X can go ahead and return to A the money backing A's answer. The answer provided by A can remain available for purchase on the exchange for as long as A allows X to keep an electronic copy of A's evidence.

In one embodiment, $0.50 of every $1.00 of Q's that transacts is set aside to pay A, if A turns out to be correct. To encourage referrals, $0.10 of every $1.00 of Q's that transacts is set aside to pay referrers. The remaining $0.40 of every $1.00 of Q's that transacts is paid to X. The division of every $1.00 of Q's that transacts into $0.50 to A, if correct; $0.10 to referrers; and $0.40 to X is of course only one of many possible divisions. All other such divisions are included as possible embodiments of the present invention.

For fill-in-the-blank questions, in one embodiment, every $1.00 from Q transacts against each answerer's $0.50, and the amount A stands to lose is equal to the amount A stands to gain. That is, for every $1.00 from Q, A stands to lose $0.50, and A stands to gain $0.50. Other embodiments include A standing to gain more or less than she stands to lose and the possibility of Q and A negotiating up front the amount A stands to lose and the amount A stands to gain.

Answers to Yes/No questions take the form of a number between 0% and 100%. The formula for A's payout is designed to incentivize A to provide a number that closely reflects her belief the answer to the question is “Yes.” The answerer's payout depends on (i) a₁, the number (between 0% and 100%) provided by A; (ii) q₁, Q's initial belief (a number between 0% and 100%) the answer to the question is “Yes”; and (iii) whether the Final Answer to the question turns out to be “Yes” or “No.” A receives a positive payout (and here and below will be considered “correct”) if the information exchange approved Final Answer turns out to be “Yes” and a₁>q₁, or if the information exchange approved Final Answer turns out to be “No” and a₁<q₁. If the information exchange approved Final Answer turns out to be “Yes” and a₁<q₁, or if the information exchange approved Final Answer turns out to be “No” and a₁>q₁, then A's money that has transacted is forfeited to X (and A here and below will be considered “incorrect”).

Answers to multiple-choice questions can take the form of one number between 0% and 100% for each possible answer of the question's N possible answers. The N possible answers should always include the possible answer “Other.” The N possible answers are understood to be mutually exclusive, so the N numbers always sum to 100%. For example, for a question with N=4 possible answers, the answerer A might believe the first possible answer is correct with a probability of 10%, the second possible answer is correct with a probability of 60%, the third possible answer is correct with a probability of 25%, and the fourth possible answer [“Other”] is correct with a probability of 5%. The probability assigned to “Other” could be assigned directly by Q, or could be automatically calculated as the remainder when the other probabilities are assigned. Additionally, the probabilities can be implicitly assigned to the possible answers using relative weights. For example, if the possible answers are assigned weights of 2, 12, 5, and 1, respectfully, the resulting probabilities would be the same as the example above. For multiple-choice questions with information exchange approved Final Answer corresponding to a given possible answer, A's payout depends on (i) the probability (between 0% and 100%) provided by A for that possible answer; and (ii) Q's initial belief (a number between 0% and 100%) the answer to the question is that possible answer. For multiple-choice questions with information exchange approved Final Answer corresponding to such possible answer, A receives a positive payout, and here and below will be considered “correct,” if (i)>(ii). If (i)<(ii), some or all of A's money that has transacted is forfeited to X, and A here and below will be considered “incorrect.” Note that the payout rules for multiple-choice questions coincide with the payout rules for Yes/No questions in the limiting case of multiple-choice questions with two possible answers (“Yes” and “No” [equivalently, “Yes” and “Other”]).

For both Yes/No and multiple-choice questions, (i) Q can provide her initial belief before making a purchase, if she so chooses; (ii) A's potential gain and potential loss is computed using a formula involving the logarithmic difference between the probability provided by A and Q's initial belief, for each possible answer. A is incentivized to answer a Yes/No or multiple-choice question only if she suspects she is more informed than Q, since only in this case is A's expected payoff positive.

It is possible to make small, systematic adjustments to probabilities, including but not limited to adjustments to small probabilities (<1%) and large probabilities (>99%) to better align incentives and to accommodate known or suspected human biases in assessing such probabilities. It is also possible to report probabilities in a manner considered helpful for aligning incentives and accommodating known or suspected biases, including but not limited to reporting an answer of (say) 0.3% as “<1%,” reporting an answer of (say) 99.7% as “>99%,” and in choosing the number of significant digits to display.

If A answers a question, any money held in escrow by X that does not transact before an agreed upon date is returned to A on the following day. If A's money does transact, in part or in full, there are three possible outcomes. If Q provides an information exchange approved Final Answer indicating A is correct, X returns to A her money that transacted plus profit, computed in a manner described above. If Q provides an information exchange approved Final Answer indicating that A is incorrect, A forfeits her amount that transacted. A's transacted amount is added to a pot, the contents of which are distributed monthly to people who answered questions on the information exchange that month, in proportion to the money backing each person's answer. Note that this requires both (a) Q providing a Final Answer indicating A is incorrect, and (b) X approving Q's evidence justifying Q's Final Answer. If Q does not provide an information exchange approved Final Answer by the agreed upon deadline, X makes available to A in full, without gain or loss, A's money that transacted. In such circumstance, X may award a gain of an amount between $0 and the profit A would have obtained had Q provided an information exchange approved Final Answer in A's favor.

A few simple, worked examples follow. The first two examples consider a Yes/No question where Q and X, respectively, are responsible for providing the Final Answer. The third example involves a multiple-choice question. The fourth example involves a fill-in-the-blank question where A is responsible for providing the Final Answer.

As a first example, consider a Yes/No question for which Q is willing to pay $20. Q's initial belief the answer is “Yes” is 50%. Q expects to learn the Final Answer by 2018 Jan. 31. Q provides a matching $20 deposit. Answerer A provides an answer of 5%, backed by $20 to be held in escrow until 2018-02-01.

The constraints noted earlier (i.e., A's money must be held in escrow beyond the Final Answer deadline, and the amounts available for transaction must meet or exceed both Q's and A's minimum transaction amount) are satisfied in this case, so a transaction will occur.

According to the payout algorithm described previously in this Section, if the Final Answer turns out to be “No”, A's payout will be

$$\$ z log ( \frac{1 - 0.05}{1 - 0.50} ) ,$$

a positive quantity, for some z, where log denotes the natural logarithm. If the Final Answer turns out to be “Yes”, A's payout will be

$$\$ z log ( \frac{0.05}{0.50} ) ,$$

a negative quantity, for the same z. The condition that A must not stand to lose more than she has in escrow constrains

$$\$ z log ( \frac{0.05}{0.50} ) \geq - \$20 ,$$

or z [symbol] 8.69. In addition, A must not stand to make more than the amount available to pay A. In this embodiment, the amount available to pay A is 50% of the amount paid by Q. This constrains

$$\$ z log ( \frac{1 - 0.05}{1 - 0.50} ) \leq \$20 \times 50 \% = \$10 ,$$

or z [symbol] 15.58. The constraint that A may not stand to lose more than she has in escrow is therefore binding, and we set z=8.69. A's full $20 transacts. Of the $20 Q is willing to pay,

$$\$11 .15 ( = \$8 .69 log ( \frac{1 - 0.05}{1 - 0.50} ) / 50 \% )$$

transacts.

Q's remaining $8.85 (=$20−$11.15) is left on the book, where it may subsequently transact with another answerer. Q can thus benefit from multiple answerers, receiving updated beliefs from X as they are provided, with X aggregating beliefs, weighted by the amount of Q's money that transacts for each belief.

X will return Q's $20 deposit if Q tells X the Final Answer by 2018, Jan. 31, providing sufficient justification to convince X beyond reasonable doubt. If the Final Answer turns out to be “Yes”, A will lose her $20. If the Final Answer turns out to be “No”, A will get back her $20, plus a profit of

$$\$5 .58 ( = \$8 .69 log ( \frac{1 - 0.05}{1 - 0.50} ) ) .$$

More complicated scenarios are straightforwardly handled with repeated application of the rules detailed in Section B, in the manner illustrated in this simple example.

In the second example we will consider, X provides the Final Answer to a Yes/No question. As a variation of the first example, consider the same Yes/No question for which Q is willing to pay $20. As before, Q provides a matching $20 deposit; Q's initial belief the answer is “Yes” is 50%; Q expects to learn the Final Answer by 2018, Jan. 31; and A provides an answer of 5%, backed by $20 to be held in escrow until 2018-02-01.

Suppose X accepts responsibility for determining the Final Answer. X returns Q's $20 deposit immediately after accepting responsibility for determining the Final Answer.

As in the first example, Q's $11.15 transacts against A's full $20; X is paid $4.46 (=$11.15×40%); referrers are paid $1.12 (=$11.15×10%), using an algorithm that will be described in Section C; A stands to lose her $20 if she is wrong; and A stands to make $5.58 if she is right.

If A turns out to be wrong and X has not accepted responsibility for determining the Final Answer (as in the first example), the money A loses gets put in a pot that is distributed to answerers.

If A turns out to be wrong and X has accepted responsibility for determining the Final Answer, the money A loses, up to the total amount paid by Q, is given to Q. Only money over and above the total amount paid by Q, if any, gets put in a pot that is distributed to answerers. In this case, if A turns out to be wrong, Q gets her full $20 back; X is paid $4.46 (=$11.15×40%); referrers are paid $1.12 (=$11.15×10%); and the remaining $14.42 (=$20−$4.46−$1.12) is added to a pot that is distributed to answerers.

Not all questions can be asked in a way that X can accept responsibility for determining the Final Answer. Some questions can, though, and in such cases it is clearly in Q's interest to do so. For such questions, if Q receives an incorrect answer, Q gets (at least some of, and possibly all of) her money back. In practice, answerers seem more willing to answer questions that will have unambiguous Final Answers, so the extra effort Q expends to turn her question into one that will have an obviously unambiguous and easily determinable Final Answer improves Q's chances of receiving an informed answer. X is willing to accept responsibility for determining the Final Answer for such questions as a matter of policy, since such questions are more likely to result in transactions and less likely to result in Final Answer disputes. Requiring Q to put up her deposit before X decides whether to accept responsibility for determining the Final Answer makes it less attractive for Q to try asking a tricky question that gets her a useful answer and her money back because some trickery in the question, taken literally, makes the reasonable answer strictly incorrect.

For our third example, consider a multiple-choice question with three possible answers: A, B, and C, where choice C corresponds to “other.” Q's initial beliefs in these three possible answers are 30%, 35%, and 35%, respectively. X holds the $20 Q is willing to pay for updated beliefs, together with the matching $20 deposit that will be returned to Q if she learns the Final Answer by the date she has specified (2018, Jan. 31).

Answerer A, who considers answer A to be the most likely of the three possibilities, provides beliefs of 80%, 17%, and 3% for possible answers A, B, and C, respectively. Answerer A backs her answer with $20 to be held in escrow until 2018-02-01.

A transaction will occur. If the Final Answer turns out to be A, B, or C, respectively, answerer A's payout will be

$$\$ z log ( \frac{80 \%}{30 \%} ) , \$ z log ( \frac{17 \%}{35 \%} ) , or \$ z log ( \frac{3 \%}{35 \%} ) ,$$

respectively, for some $z. If the Final Answer turns out to be choice A, answerer A will make money. If the Final Answer turns out to be choice B or choice C, answerer A will lose money. Answerer A cannot stand to make more than is available for her to make, constraining

$$\$ z log ( \frac{80 \%}{30 \%} ) \leq \$20 \times 50 \% = \$10 .$$

Answerer A cannot stand to lose more than her $20 backing her answer, constraining

$$\$ z log ( \frac{17 \%}{35 \%} ) \geq - \$20$$

and

$$\$ z log ( \frac{3 \%}{35 \%} ) \geq - \$20 .$$

Maximizing $z while respecting these constraints, the last of which is binding, leads to $z=$8.14. A's full $20 transacts. Of the $20 Q is willing to pay,

$$\$15 .97 ( = \$8 .14 log ( \frac{80 \%}{30 \%} ) / 50 \% )$$

transacts, and $4.03 (=$20−$15.97) is left on X's book, where it may subsequently transact with another answerer. If the Final Answer turns out to be A, B, or C, respectively, answerer A's profit will be +$7.98, −$5.88, and −$20, respectively. That is, if the Final Answer turns out to be A, answerer A will get her $20 back, plus $7.98 in profit; if the Final Answer turns out to be B, answerer A will get $14.22 of her $20 back; and if the Final Answer turns out to be C, answerer A will lose her full $20.

The intuition behind this multiple-choice example is reasonably straightforward. Answerer A clearly makes money if the Final Answer turns out to be choice A, since answerer A's 80% is greater than Q's initial belief of 30%. Answerer A clearly loses money if the Final Answer turns out to be choice C, since answerer A's 3% is significantly less than Q's initial belief of 35%. If the Final Answer turns out to be choice B, then answerer A is wrong, but not as badly wrong as if the Final Answer had turned out to be choice C, so answerer A loses money, but not as much money as if the Final Answer had turned out to be choice C.

In the fourth and final example we will consider, A provides the Final Answer to a fill-in-the-blank question. Suppose A lives in The Condor, a large apartment building. A's apartment (#8A) is very similar to apartments A, B, C, and D on floors 7, 8, and 9 of The Condor. A is willing to sell the amount she is paying in rent to anyone willing to pay her $50, as long as A can retain some anonymity. A can therefore pose the question “What did someone in apartment A, B, C, or D on floor 7, 8, or 9 of The Condor pay in rent for the month of May 2016?”, together with a clarifying paragraph or two. A provides the amount she is paying in rent as her answer, backed by her $50.

A then submits to X evidence supporting her answer, in the form of a monthly bill from The Condor. X determines this evidence to be sufficient, and returns A's $50 to A. Q, a potential purchaser, sees that someone has provided evidence that X considers sufficient. Q can purchase the answer for $100. Of Q's $100, $50 is paid immediately to A, $40 is paid to X, and $10 is set aside to be paid to referrers using an algorithm described in Section C. For $100, Q sees A's answer. Q does not see A's evidence. Q does not provide a deposit, and Q bears no responsibility for independently determining the Final Answer.

This payout structure is appropriate for questions for which Q has no easy means of independently determining the Final Answer, and for which A can provide evidence backing her answer that X considers sufficient. Recognizing A's incentives in this payout structure, X sets a high bar for evidence to be considered sufficient.

Moreover, there are multiple correct answers to the question “What did someone in apartment A, B, C, or D on floor 7, 8, or 9 of The Condor pay in rent for the month of May 2016?”, all of which could be for sale on the exchange. The disclosed information exchange operates in the same manner for multiple transactions. In some embodiments, Q can specify how many answers to purchase and the manner in which to select them, such as by minimum sell price, order of submission, date of submission, or various other criteria.

To summarize Section B, we have described a transaction protocol that aligns the incentives of parties involved in the exchange of information whose form is specified by the package detailed in Section A. This transaction protocol involves the information exchange X holding in escrow money from both the questioner Q and answerer A; imposing a set of constraints on allowed transactions; in some cases, paying Q to eventually provide the Final Answer, with justification; and paying those answerers who turn out to be correct. The timeline of each transaction is well defined, strict, and agreed upon up front by buyer and seller. The issue of determining the correct answer is in most cases resolved by incentivizing Q to ask a question for which she will eventually know the Final Answer, and, in appropriate cases, paying Q to provide the Final Answer with enough evidence (usually just a couple of sentences and a link, image, or video) that an intelligent but non-expert adjudicator at the information exchange can quickly agree the Final Answer provided has been justified beyond reasonable doubt. Q's misaligned incentive to provide a Final Answer (even if it cannot be adequately justified) is balanced by X's strong business incentive to be viewed as an objective and fair adjudicator of the evidence. The amount of money X makes on any individual transaction is unaffected by whether X approves or denies Q's eventual Final Answer. The desire to appropriately align incentives at each step of the transaction, including the incentives of X itself, motivates the transaction protocol described in this embodiment.

Having described the form of the information package to be exchanged (Section A) and the transaction protocol by which it will be exchanged (Section B), it remains to effectively find people willing and able to accurately answer questions posed, and to find people willing to pay for answers that have been offered (Section C).

Section C. Matching Questions with Answers

For many of the most valuable questions, there may be only a handful of people worldwide able to provide the answer. Most existing question and answer platforms, “ask the expert” platforms, and prediction markets assume (implicitly or explicitly) a pool of active participants with some knowledge about the questions being asked on the platform. Benefits can be achieved by actively matching questions with potential answerers, including answerers not yet aware of the information exchange, and including answerers who may not have realized they have information for which someone else is willing to pay. For transactions initiated by answerers, similar benefits can be achieved by actively matching answers with people potentially willing to pay for the answer, including people not yet aware of the information exchange, and including people who may not have realized they could benefit from knowing the answer to some particular question.

In one embodiment, the user who initiates a question may choose whether the question is visible to anyone browsing the information exchange, or whether the question is restricted to people who have been explicitly invited to view it. Questions that are publicly viewable are more likely to be viewed and to receive answers, but there may be reasons the questioner would prefer the question be viewable by a restricted audience. Similarly, answerers who initiate questions may choose whether the question is visible or hidden. It is more likely someone will view the question and decide she is willing to pay for the answer if the question is publicly viewable, but there may be reasons the answerer initiating the question would prefer the question be viewable by a restricted audience.

Since the questioner (Q) often knows who may know the answer to her question, one embodiment allows Q to provide the email addresses or other contact information of people she thinks may know the answer to her question. The information exchange may then, at its discretion and perhaps after automated checking of the reasonableness of the suggestions, extend personal invitations to those individuals, by email, text, instant messaging, or some other communication technology, alerting these individuals to the existence of the question and the opportunity to profit by answering it.

The information exchange may also allow individuals browsing questions to suggest one or more people who may know the answer to a particular question, and may allow individuals invited to view a particular question to suggest one or more people who may know the answer to that question.

To increase the probability of a question receiving an answer, it is helpful for the information exchange itself to identify individuals likely to know the answer, and to extend to them personal invitations, alerting them to the existence of the question and the opportunity to profit by answering it, whether the question is publicly visible or hidden.

The above holds similarly in matching answers with people potentially willing to pay for those answers.

Money can be used as an incentive to encourage quality referrals. In one embodiment, $0.10 of every $1.00 that transacts is set aside to pay referrers. This money can be divided among referrers in various ways, with the details of the distribution fine-tuned to elicit desired behavior. This section briefly describes one useful way referral rewards may be distributed. Other distributions will be readily apparent to those skilled in the art.

The procedure by which the information exchange X pays referrers is intended to promote an efficient matching of questions and answers while preserving the anonymity of those being referred. If the eventual answerer comes to X through a referral, the referrer receives a “referrer credit” of $0.05 (half of the $0.10 set aside for referrers) for every $1.00 that transacts. If the referrer was herself referred, the secondary referrer receives a referrer credit of $0.025 (half of the remaining $0.05 set aside for referrers) for every $1.00 that transacts. If the secondary referrer was herself referred, the tertiary referrer receives a referrer credit of $0.0125 (half of the remaining $0.025 set aside for referrers) for every $1.00 that transacts. This allocation of referrer credit continues, halving with each step, all the way back to the initial referrer in the chain that led to the eventual answerer.

To protect the anonymity of those being referred, referrer credits are not paid out directly. Referrer payouts are instead determined on the first of every month by lottery, with multiple winners. The first winner receives 10% of the previous month's referrer pot; the second winner receives 10% of the remaining pot (9% of the original pot); the third winner receives 10% of the remaining pot (8.1% of the original pot); and so on. The probability of any particular referrer being the first winner is 5% divided by the total number of referrers the previous month, plus 20% times the number of her referrals approved by the information exchange divided by the total number of referrals approved by X, plus 75% times her referral credit the previous month divided by the total of everyone's referral credit over the same period. After the first winner is selected, she is removed from consideration, and probabilities are recalculated for all remaining referrers for the lottery's second round. This process continues until (i) the entire referrer pot for the month has been distributed, or (ii) all referrers have been selected as winners. If the lottery stops due to (ii), any remaining money is split equally among the referrers. Referrers must provide some means of contact (such as an email address) to receive credit for their referral. Questioners who suggest potential answerers are eligible for referral rewards. X and its employees should be ineligible for referral rewards, even if X's algorithms are responsible for identifying the eventual answerer.

The distribution method described above holds similarly for referrers who assist in matching answers with people potentially willing to pay for those answers.

Present technology significantly facilitates the matching of questions with potential answerers and the matching of answers with people potentially willing to pay for those answers. This technology is evolving rapidly. Described below are several ways of matching questions with potential answerers. We omit, in the interest of brevity, many other methods that will be readily apparent to a person skilled in the art.

Questions often contain reference to a geospatial location, which may be turned into (latitude, longitude) coordinates. The location may be provided in the form of an explicit street address or a reference to a person, place, or object with which a geospatial location may be easily associated. Depending on the type of location, a geospatial area may be more appropriate than a geospatial point. Some questions contain a reference to a specific date and time, or to a range of dates and times. When both location and time coordinates or coordinate ranges are provided, software can associate a space-time point or a space-time range with the question. For any particular question, this information can be computed, cached, and used to help quickly determine whether to show a user browsing questions on the exchange that particular question. This information can also be used to identify people likely to know the answer to the question, whether or not they are already active participants on the exchange.

Questions often contain words and word phrases that may be used to identify potential answerers. Software can identify the key words or word phrases present in the short form and/or long form of a question, and can use these to find likely answerers. In practice, capitalized words and word phrases in the question text are among those most frequently useful for this purpose.

Many questions reference specific people, companies, places, or organizations. In these cases, social networks can often be used to identify likely answerers.

To summarize, an effective information exchange should expect to take an active role in matching questions with potential answerers and in matching answers with people potentially willing to pay for those answers. Several different channels may be used to encourage this matching, including targeting the browsing user; allowing users to refer other users, perhaps with an explicit economic incentive; and using any of various automatically executed algorithms implemented in software.

An information exchange in accordance with the above disclosure is implemented using a computer system having at least a processor, memory, a network interface, and a storage medium for storing program instructions and records reflecting transaction information. Through the use of a computer system, the participants can exchange information in an anonymous and secure fashion. The various communications involved in the operation of the information exchange can be thought of as comprising records. These records represent an associated collection of data and are not necessarily stored or communicated as a single unit.

For example, FIG. 5 depicts various types of information associated with a buy order, including a question, a category of acceptable answers, and an amount that a participant is willing to pay to have the question answered. Not depicted in FIG. 5, but also present is an association with an account that can be credited, if certain conditions are met. These conditions might include, but are not limited to, returning Q's deposit if Q provides a timely Final Answer that X approves, and returning any money that Q was willing to pay that did not transact. This association to an account might be direct or indirect and could be represented in any number of forms. Moreover, “account” refers to the general mechanism used to transact with participants and could include a bitcoin wallet, or an identifiable recipient for a negotiable instrument, for example. Additionally, the accounts used for transfers from Q or A may not be the same as the accounts used to transfer to Q or A, respectfully. For example, deposits might be submitted by credit card with payouts or refunds returned via a wire transfer. Furthermore, transfers need only transfer control and not necessarily the financial account were the funds are held. For example, a “transfer” might include placing a hold on funds held by a financial institution such that the account holder maintains possession yet has lost the ability to control distribution of those funds. In other cases, an account could be considered to be an amount owed to the exchange for either a deposit or purchase.

The information for a buy order, including what is illustrated in FIG. 5, could be stored in any of a number of forms. As one option, the information may be stored as a single record representing a buy order. Alternatively, the question and the category of acceptable answers could be used to form a question record with the remaining information, together with a link to the associated question record, used to form the record for a buy order. However all these data are stored, there must be a mechanism for maintaining sufficient association among records to enable the disclosed exchange of information. In contrast, aside from a means of transferring funds and a way to display to a buyer an answer she has paid for, no data connecting the buy order to a buyer or other originator of the buy order is strictly required. Similarly, aside from a means of transferring funds, no data connecting a sell order to a seller or other originator of the sell order is strictly required.

In one embodiment, questions are represented as question records containing the question to be answered and the set of allowed possible answers. There are also records representing buy orders, each containing: an association with a question record; a buy price (“I am willing to pay” in FIG. 5); and a required response date (i.e., “I want to know by” in FIG. 5); either (i) an indication the buyer will eventually know the Final Answer (“I will eventually know the Final Answer” in FIG. 5) and a buyer verification date (“I will know the Final Answer by” in FIG. 6) by which the buyer will transmit a Final Answer and supporting evidence, or (ii) an indication that the buyer will be able to verify the accuracy of answers received (“I will be able to verify the accuracy of any answer I receive” in FIG. 5) and the time (e.g., 7 days) after receiving the answer by which the buyer will be able to determine the accuracy of the received answer and provide supporting evidence; a buy deposit amount; and an identifier of an account (not necessarily with a financial institution) that is to be used to transact with respect to this buy order. In other embodiments, a buy order could include a user identifier that is linked to a user record. In such cases, a bank account, for example, could be identified indirectly via this user record. Similarly, some embodiments include a record representing a sell order containing: an association with a question record; an answer to the question of said question record; a minimum sell price, corresponding to the minimum amount for which the seller is willing to sell her answer; a sell deposit amount, corresponding to the amount the seller is willing to lose should her answer turn out to be incorrect; and an identifier of an account that is to be used to transact with respect to this sell order. The above described records may contain information directly or indirectly via references to the location where the data can be obtained.

As described above, submission of a Final Answer must be accompanied by evidence justifying the accuracy of that Final Answer. This evidence can be thought of in terms of an evidence record, which could contain files, images, video clips, hyperlinks, or other information justifying a Final Answer. In one embodiment, an evidence record contains a Final Answer, the evidence provided to support that Final Answer, and an association with the relevant question record. Alternatively, the information within an evidence record may be stored as associations rather than as values, or may be stored within the question record or within other records used by the information exchange. An evidence record represents a convenient way to refer to the information that the exchange uses to verify Q's identification of the Final Answer. In some embodiments, the evidence record may also include an indication as to whether the information was submitted by Q, X, or A.

Once X has determined that the accuracy of a Final Answer has been sufficiently established, this status can be reflected using a verification record. A verification record can be represented as an association between a question record and the verified Final Answer to the associated question. A verification record might also contain an indication that the evidence supporting the submitted Final Answer has been determined to be insufficient, that the time for submission of a Final Answer has elapsed, or other information related to the verification process, including, for example, an indication that evidence has been received and verification is pending. The information reflected by a verification record might be stored independently, within a question record itself, or within other records of the information exchange.

The information exchanged and the information used to operate the exchange can be obtained via one or more web interfaces. FIGS. 1-6 depict various portions of a web interface that could be used to obtain information to create various computer records, such as a question record and a buy order. Other information associated with an order or record can be obtained separately. For example, the buy account identifier for a buy order can be inferred from the identity of a logged-in user submitting the question. Alternatively, account information can be obtained before a question is submitted. As another alternative, account information could be obtained after a question has been provisionally accepted. In some embodiments, participants could interact with the information exchange via stand-alone applications that do not necessarily communicate using communications protocols associated with websites. The same interfaces used to obtain information for various records can also be used to disclose to the buyer the information purchased. In many cases, the purchaser can access a website associated with an information exchange and have this information displayed on her screen. In other embodiments, the purchased information can be transmitted electronically via e-mail, possibly using encryption

To further facilitate the exchange of information, computer systems of the information exchange are configured to initiate transfers to and from accounts associated with buy orders and sell orders. The transfers are used to effect deposits, escrow, purchases, payouts and any other transactions that may be associated with the information exchange. These transfers can utilize the existing EFT system for bank account transfers, or they can be configured to utilize other payment systems that do not utilize financial institutions. In some cases, the computer systems can initiate transfers between accounts maintained by X. For example, in circumstances where a participant has a high transaction volume, it may be beneficial to limit the number of external transactions.

Although the present invention and its advantages have been described in detail, it should be understood that various changes, substitutions and alterations can be made to the embodiments described herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A computer system comprising:
a processor;
a memory;
a network interface;
a storage medium comprising programming instructions that when executed cause the computer system to:
receive a question record comprising:
a question that can be objectively answered; and
a set of allowed possible answers;
receive a buy order comprising:
an association with the question record;
a buy price;
a buy order deposit; and
an identifier for a buyer account;
initiate a transfer from the buyer account corresponding to the buy price;
initiate a transfer from the buyer account corresponding to the buy order deposit;
receive a sell order comprising:
an association with the question record;
a sell answer to the question in the associated question record;
a minimum sell price;
a sell order collateral; and
an identifier for a seller account;
initiate a transfer from the seller account corresponding to the sell order collateral;
receive an evidence record comprising:
an association with the question record;
a final answer to the question of the associated question record; and
information related to the accuracy of said final answer;
receive a verification record comprising:
an association with the question record; and
an indication that the final answer has been accepted as accurate;
initiate a transfer to the buyer account an amount corresponding to at least a portion of the buy order deposit, if the evidence record was submitted on or before a buyer verification date and its final answer has been accepted as accurate;
compare the final answer, if accepted, with the sell answer to determine the accuracy of the sell answer;
initiate a transfer to the seller account an amount corresponding to at least a portion of the buy price, if the sell answer is determined to be at least partially accurate; and
disclose the sell answer in relation to the buy order, if the buy price is at least the minimum sell price.

2. The system of claim 1, wherein the final answer of the evidence record comprises a statement regarding the accuracy of the sell answer without an independent answer to the question of the question record itself.

3. The system of claim 1, wherein the storage medium further comprises programming instructions that when executed cause the computer system to:
withdraw a buy order; and
initiate a transfer to the buyer account of at least a portion of the amount by which the buy price exceeds the minimum sell price.

4. The system of claim 1, wherein the set of allowed possible answers is a category.

5. The system of claim 1, wherein the set of allowed possible answers consists of a finite list of mutually exclusive answers, wherein the buy order further comprises a probability assigned to each member of the finite list wherein the sum total of all assigned probabilities is equal to one.

6. The system of claim 5, wherein:
the question of a question record is a yes/no question; and
the set of allowed possible answers is either yes or no.

7. The system of claim 5, wherein the sell answer further comprises a probability assigned to each member of the finite list wherein the sum total of all assigned probabilities is equal to one.

8. The system of claim 7, wherein the comparison between the final answer, if accepted, and the sell answer further includes a comparison between the probability assigned to the answers in the sell order and the probabilities assigned to the possible answers in the buy order.

9. The system of claim 1, wherein the programming instruction to initiate a transfer from the buyer account corresponding to the buy price and the programming instruction to initiate a transfer from the buyer account corresponding to the buy order deposit are configured to execute concurrently as part of a single transaction.

10. A method for electronically exchanging information comprising:
receiving a question record comprising:
a question that can be objectively answered; and
a set of allowed possible answers;
receiving a buy order comprising:
an association with the question record;
a buy price;
a buy order deposit; and
an identifier for a buyer account;
initiating a transfer from the buyer account an amount corresponding to the buy price;
initiating a transfer from the buyer account an amount corresponding to the buy order deposit;
receiving a sell order comprising:
an association with the question record;
a sell answer to the question in the associated question record;
a minimum sell price;
a sell order collateral; and
an identifier for a seller account;
initiating a transfer from the seller account an amount corresponding to the sell order collateral;
receiving an evidence record comprising:
an association with the question record;
a final answer to the question of the associated question record; and
information related to the accuracy of said final answer;
generating a verification record comprising:
an association with the question record; and
an indication that the final answer has been accepted as accurate;
initiating a transfer to the buyer account an amount corresponding to at least a portion of the buy order deposit, if the evidence record is received on or before the buyer verification date and its final answer has been accepted as accurate;
comparing the final answer, if accepted, with the sell answer to determine the accuracy of the sell answer;
initiating a transfer to the seller account corresponding to at least a portion of the buy price, if the sell answer has been determined to be at least partially accurate; and
disclosing the sell answer in relation to the buy order, if the buy price is at least the minimum sell price.

11. The method of claim 10, wherein the step of receiving a sell order associated with the question record occurs before the step of receiving a buy order associated with said question record.

12. The method of claim 10, wherein the step of receiving a buy order comprises receiving more than one buy order having an association with the question record.

13. The method of claim 10, wherein the step of disclosing the sell answer in relation to the buy order comprises disclosing a plurality of sell answers, if the buy price exceeds at least the sum of the minimum sell prices associated with the plurality of sell answers.

14. The method of claim 13, further comprising the steps of:
withdrawing a buy order; and
initiating a transfer to the buy account of at least a portion of the amount by which the buy price exceeds the sum of the minimum sell prices.

15. The method of claim 10, further comprising the steps of:
receiving a list of one or more potential answer providers for a question record; and
transmitting to a potential answer provider a request to submit a sell order associated with the question record.

16. The method of claim 10, further comprising the steps of:
receiving a list of one or more potential answer purchasers for a sell order; and
transmitting to a potential answer purchaser a request to submit a buy order associated with the sell record.

17. The method of claim 10, wherein the set of allowed possible answers is a category.

18. The method of claim 10, wherein the set of allowed possible answers consists of a finite list of mutually exclusive answers, wherein each member of the finite list is assigned a probability and wherein the sum total of all assigned probabilities is equal to one.

19. The method of claim 18, wherein:
the question of a question record is a yes/no question; and
the set of allowed possible answers is either yes or no.

20. The method of claim 10, wherein the step of receiving a sell order comprises receiving more than one sell order having an association with the question record.

21. The method of claim 10, wherein the buy order does not contain information associated with a buyer other than an identifier for a buyer account.

22. The method of claim 10, wherein the sell order does not contain information associated with a seller other than an identifier for a seller account.
